(19) United States
(12) Patent Application Publication
(10) Pub. No.: US 2025/0254674 A1
(43) Pub. Date: Aug. 7, 2025

(54) INFORMATION TRANSMISSION METHOD AND APPARATUS, INFORMATION PROCESSING METHOD AND APPARATUS, AND COMMUNICATION DEVICE

(71) Applicant: VIVO MOBILE COMMUNICATION CO., LTD., Dongguan (CN)

(72) Inventors: Qianyao REN, Dongguan (CN); Hao WU, Dongguan (CN)

(21) Appl. No.: 19/190,649

(22) Filed: Apr. 27, 2025

Related U.S. Application Data
(63) Continuation of application No. PCT/CN2023/125560, filed on Oct. 20, 2023.

(30) Foreign Application Priority Data
Oct. 27, 2022 (CN) 202211328601.6

(51) Int. Cl. H04W 72/0453; H04L 41/16

(52) U.S. Cl. CPC H04W 72/0453; H04L 41/16

(57) ABSTRACT

This application discloses an information transmission method and apparatus, and a communication device. The information transmission method includes: a terminal determines K groups of second channel information from first channel information based on first information, where the first information includes group information of K groups of frequency domain resources, the K groups of second channel information are in a one-to-one correspondence with the K groups of frequency domain resources, each of the K groups of frequency domain resources includes at least one frequency domain resource; the terminal performs first processing on M groups of second channel information based on first AI network models respectively corresponding to the M groups of second channel information, to obtain M pieces of channel characteristic information; and the terminal sends second information to a network side device, where the second information includes the M pieces of channel characteristic information.

### CROSS-REFERENCE TO RELATED APPLICATIONS

This application is a continuation of International Patent Application No. PCT/CN2023/125560, filed on Oct. 20, 2023, which claims priority to Chinese Patent Application No. 202211328601.6, filed on Oct. 27, 2022 in China, both of which are incorporated herein by reference in their entireties.

### TECHNICAL FIELD

This application pertains to the field of communication technologies, and specifically relates to an information transmission method and apparatus, an information processing method and apparatus, and a communication device.

### BACKGROUND

In a related technology, a method for transmitting channel characteristic information by using an AI network model is studied.

The AI network model may include an encoding part (that is, an encoding AI network model) and a decoding part (that is, a decoding AI network model). The encoding AI network model is configured to encode channel information into channel characteristic information, and the decoding AI network model is configured to restore the channel characteristic information output by the encoding AI network model to the channel information.

In the related technology, an input dimension of a same AI network model is fixed. For channel information of different quantities of sub-bands, different AI network models need to be used. For example, an AI network model that is trained based on a precoding matrix of 13 sub-bands cannot be used on a channel with 13 sub-bands. Therefore, an AI network model that matches each quantity of sub-bands needs to be trained and transferred.

### SUMMARY

Embodiments of this application provide an information transmission method and apparatus, an information processing method and apparatus, and a communication device, so that an AI network model that is trained based on channel information of a low quantity of sub-bands can process channel information of a high quantity of sub-bands, thereby improving multiplexing efficiency and flexibility of the AI network model.

According to a first aspect, an information transmission method is provided, and the method includes:
determining, by a terminal, K groups of second channel information from first channel information based on first information, where the first information includes group information of K groups of frequency domain resources, the K groups of second channel information are in a one-to-one correspondence with the K groups of frequency domain resources, each group of frequency domain resources in the K groups of frequency domain resources includes at least one frequency domain resource, and K is an integer greater than or equal to 1;
performing, by the terminal, first processing on M groups of second channel information based on first AI network models respectively corresponding to the M groups of second channel information, to obtain M pieces of channel characteristic information, where the K groups of second channel information include the M groups of second channel information, and M is a positive integer less than or equal to K; and
sending, by the terminal, second information to a network side device, where the second information includes the M pieces of channel characteristic information.

According to a second aspect, an information transmission apparatus is provided. The apparatus is applied to a terminal and includes:
a first determining module, configured to determine K groups of second channel information from first channel information based on first information, where the first information includes group information of K groups of frequency domain resources, the K groups of second channel information are in a one-to-one correspondence with the K groups of frequency domain resources, each group of frequency domain resources in the K groups of frequency domain resources includes at least one frequency domain resource, and K is an integer greater than or equal to 1;
a first processing module, configured to perform first processing on M groups of second channel information based on first AI network models respectively corresponding to the M groups of second channel information, to obtain M pieces of channel characteristic information, where the K groups of second channel information include the M groups of second channel information, and M is a positive integer less than or equal to K; and
a first sending module, configured to send second information to a network side device, where the second information includes the M pieces of channel characteristic information.

According to a third aspect, an information processing method is provided, including:
receiving, by a network side device, second information from a terminal, where the second information includes M pieces of channel characteristic information, the M pieces of channel characteristic information are channel characteristic information obtained by performing first processing on M groups of second channel information based on first AI network models respectively corresponding to the M groups of second channel information, and M is an integer greater than or equal to 1;
determining, by the network side device based on first information, second AI network models respectively corresponding to the M pieces of channel characteristic information, where the first information includes group information of K groups of frequency domain resources, the K groups of second channel information are in a one-to-one correspondence with the K groups of frequency domain resources, each group of frequency domain resources in the K groups of frequency domain resources includes at least one frequency domain resource, and K is an integer greater than or equal to M; and
performing, by the network side device, second processing on the M pieces of channel characteristic information based on the second AI network models respectively corresponding to the M pieces of channel characteristic information, to obtain the M groups of second channel information.

According to a fourth aspect, an information processing apparatus is provided. The apparatus is applied to a network side device and includes:
a first receiving module, configured to receive second information from a terminal, where the second information includes M pieces of channel characteristic information, the M pieces of channel characteristic information are channel characteristic information obtained by performing first processing on M groups of second channel information based on first AI network models respectively corresponding to the M groups of second channel information, and M is an integer greater than or equal to 1;
a second determining module, configured to determine, based on first information, second AI network models respectively corresponding to the M pieces of channel characteristic information, where the first information includes group information of K groups of frequency domain resources, the K groups of second channel information are in a one-to-one correspondence with the K groups of frequency domain resources, each group of frequency domain resources in the K groups of frequency domain resources includes at least one frequency domain resource, and K is an integer greater than or equal to M; and
a second processing module, configured to perform second processing on the M pieces of channel characteristic information based on the second AI network models respectively corresponding to the M pieces of channel characteristic information, to obtain the M groups of second channel information.

According to a fifth aspect, a communication device is provided. The communication device includes a processor and a memory, the memory stores a program or instructions capable of running on the processor, and when the program or the instructions are executed by the processor, the steps of the information transmission method according to the first aspect or the information processing method according to the third aspect are implemented.

According to a sixth aspect, a terminal is provided, including a processor and a communication interface. The processor is configured to determine K groups of second channel information from first channel information based on first information, where the first information includes group information of K groups of frequency domain resources, the K groups of second channel information are in a one-to-one correspondence with the K groups of frequency domain resources, each group of frequency domain resources in the K groups of frequency domain resources includes at least one frequency domain resource, and K is an integer greater than or equal to 1. The processor is further configured to perform first processing on M groups of second channel information based on first AI network models respectively corresponding to the M groups of second channel information, to obtain M pieces of channel characteristic information, where the K groups of second channel information include the M groups of second channel information, and M is a positive integer less than or equal to K. The communication interface is configured to send second information to a network side device, where the second information includes the M pieces of channel characteristic information.

According to a seventh aspect, a network side device is provided, including a processor and a communication interface. The communication interface is configured to receive second information from a terminal, where the second information includes M pieces of channel characteristic information, the M pieces of channel characteristic information are channel characteristic information obtained by performing first processing on M groups of second channel information based on first AI network models respectively corresponding to the M groups of second channel information, and M is an integer greater than or equal to 1. The processor is configured to determine, based on first information, second AI network models respectively corresponding to the M pieces of channel characteristic information, where the first information includes group information of K groups of frequency domain resources, the K groups of second channel information are in a one-to-one correspondence with the K groups of frequency domain resources, each group of frequency domain resources in the K groups of frequency domain resources includes at least one frequency domain resource, and K is an integer greater than or equal to M. The processor is further configured to perform second processing on the M pieces of channel characteristic information based on the second AI network models respectively corresponding to the M pieces of channel characteristic information, to obtain the M groups of second channel information.

According to an eighth aspect, a communication system is provided, including a terminal and a network side device. The terminal may be configured to perform the steps of the information transmission method according to the first aspect, and the network side device may be configured to perform the steps of the information processing method according to the third aspect.

According to a ninth aspect, a readable storage medium is provided. The readable storage medium stores a program or instructions, and when the program or the instructions are executed by a processor, the steps of the information transmission method according to the first aspect are implemented, or the steps of the information processing method according to the third aspect are implemented.

According to a tenth aspect, a chip is provided. The chip includes a processor and a communication interface, the communication interface is coupled to the processor, and the processor is configured to run a program or instructions to implement the information transmission method according to the first aspect or the information processing method according to the third aspect.

According to an eleventh aspect, a computer program product/program product is provided. The computer program product/program product is stored in a storage medium, and the computer program/program product is executed by at least one processor to implement the steps of the information transmission method according to the first aspect, or the computer program/program product is executed by at least one processor to implement the steps of the information processing method according to the third aspect.

In the embodiments of this application, frequency domain resources are grouped, and channel information of each group of frequency domain resources is processed by using a corresponding AI network model. First channel information of one channel can be divided into K groups, and only channel information of a corresponding group of frequency domain resources is input into each AI network model, but channel information of an entire channel does not need to be input.

### BRIEF DESCRIPTION OF DRAWINGS

FIG. 1 is a schematic diagram of a structure of a wireless communication system to which embodiments of this application can be applied;

FIG. 2 is a flowchart of an information transmission method according to an embodiment of this application;

FIG. 3 is a flowchart of an information processing method according to an embodiment of this application;

FIG. 4 is a schematic diagram of a structure of an information transmission apparatus according to an embodiment of this application;

FIG. 5 is a schematic diagram of a structure of an information processing apparatus according to an embodiment of this application;

FIG. 6 is a schematic diagram of a structure of a communication device according to an embodiment of this application;

FIG. 7 is a schematic diagram of a hardware structure of a terminal according to an embodiment of this application; and

FIG. 8 is a schematic diagram of a structure of a network side device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (Long Term Evolution, LTE)/LTE-Advanced (LTE-Advanced, LTE-A) system, and may be further applied to other wireless communication systems such as Code Division Multiple Access (Code Division Multiple Access, CDMA), Time Division Multiple Access (Time Division Multiple Access, TDMA), Frequency Division Multiple Access (Frequency Division Multiple Access, FDMA), Orthogonal Frequency Division Multiple Access (Orthogonal Frequency Division Multiple Access, OFDMA), single-carrier frequency division multiple access (Single-carrier Frequency Division Multiple Access, SC-FDMA), and other systems. The terms “system” and “network” in the embodiments of this application may be used interchangeably. The technologies described can be applied to both the systems and the radio technologies mentioned above as well as to other systems and radio technologies. A new radio (New Radio, NR) system is described in the following description for illustrative purposes, and the NR terminology is used in most of the following description, although these technologies can also be applied to applications other than the NR system application, such as the 6^{th} generation (6^{th} Generation, 6G) communication system.

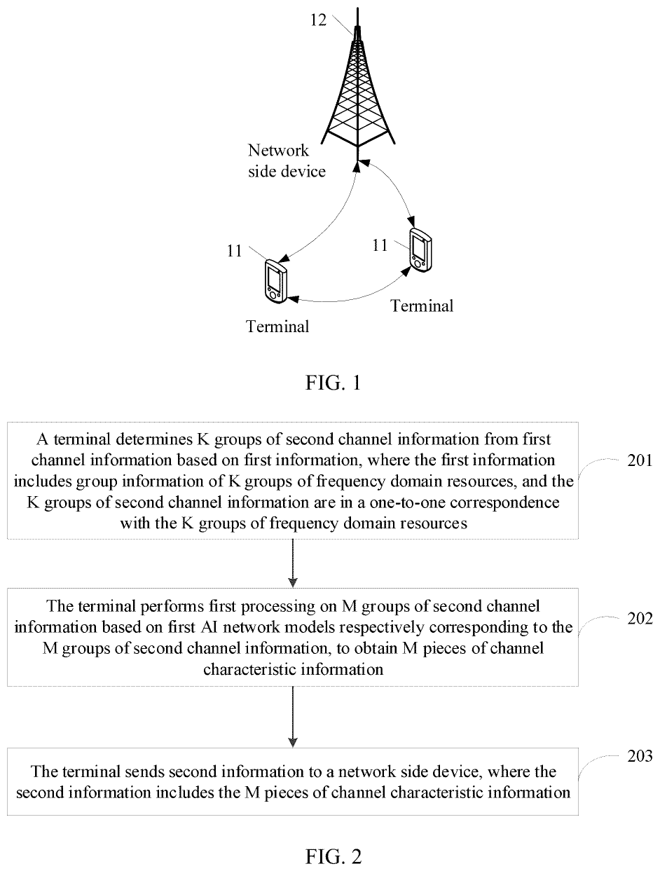

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer (Tablet Personal Computer), a laptop computer (Laptop Computer) that is also referred to as a notebook computer, a personal digital assistant (Personal Digital Assistant, PDA), a palmtop computer, a netbook, an ultra-mobile personal computer (ultra-mobile personal computer, UMPC), a mobile Internet device (Mobile Internet Device, MID), an augmented reality (augmented reality, AR)/virtual reality (virtual reality, VR) device, a robot, a wearable device (Wearable Device), vehicle-mounted user equipment (Vehicle User Equipment, VUE), pedestrian user equipment (Pedestrian User Equipment, PUE), a smart home device (a home device with a wireless communication function, such as a refrigerator, a television, a washing machine, or furniture), a game console, a personal computer (personal computer, PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a radio access network (Radio Access Network, RAN), a radio access network function, or a radio access network unit. The access network device may include a base station, a WLAN access point, a WiFi node, and the like. The base station may be referred to as a NodeB, an evolved NodeB (eNB), an access point, a base transceiver station (Base Transceiver Station, BTS), a radio base station, a radio transceiver, a basic service set (Basic Service Set, BSS), an extended service set (Extended Service Set, ESS), a home NodeB, a home evolved NodeB, a transmitting receiving point (Transmitting Receiving Point, TRP), or another proper term in the art, provided that the same technical effect is achieved. The base station is not limited to a specific technical vocabulary. It should be noted that in the embodiments of this application, a base station in an NR system is merely used as an example for description, but a specific type of the base station is not limited.

It can be learned from the information theory that accurate channel state information (channel state information, CSI) is crucial for a channel capacity. In particular, for a multi-antenna system, a transmit end may optimize signal sending based on CSI, so that signal sending matches a channel status to a larger degree. For example, a channel quality indicator (channel quality indicator, CQI) may be used to select a proper modulation and coding scheme (modulation and coding scheme, MCS) to implement link adaptation, and a precoding matrix indicator (precoding matrix indicator, PMI) may be used to implement eigen beamforming (eigen beamforming) to maximize received signal strength or to suppress interference (for example, inter-cell interference or multi-user interference). Therefore, CSI acquisition has always been a research hotspot since a multi-antenna technology (multi-input multi-output, MIMO) was proposed.

Generally, a base station sends a CSI reference signal (CSI Reference Signal, CSI-RS) on some time-frequency resources of a slot (slot). The terminal performs channel estimation based on the CSI-RS, calculates channel information on the slot, and feeds back a PMI to the base station by using a codebook. The base station combines codebook information fed back by the terminal to form channel information. Before next CSI reporting, the base station performs data precoding and multi-user scheduling by using the channel information.

To further reduce CSI feedback overheads, the terminal may change “reporting a PMI on each sub-band” into a “reporting a PMI based on a delay (delay)”. Because channels in delay domain are more centralized, PMIs of all sub-bands may be approximately represented by using PMIs of fewer delays, that is, information of the delay domain is compressed before being reported.

Similarly, to reduce overheads, the base station may pre-code the CSI-RS in advance, and send an encoded CSI-RS to the terminal. What is observed by the terminal is a channel corresponding to the encoded CSI-RS. The terminal only needs to select several ports of relatively high strength from ports indicated by a network side, and report coefficients corresponding to these ports.

Further, to better compress channel information, a neural network or a machine learning method may be used.

Currently, artificial intelligence is widely applied in various fields. An AI module has various implementations, such as a neural network, a decision tree, a support vector machine, and a Bayesian classifier. In this application, the neural network is used as an example for description, but a specific type of the AI module is not limited.

Parameters of the neural network are optimized by using an optimization algorithm. The optimization algorithm is an algorithm that helps users minimize or maximize a target function (sometimes referred to as a loss function). The target function is often a mathematical combination of a model parameter and data. For example, given data X and a corresponding label Y, a neural network model f(.) is constructed. After the model is constructed, a predicted output f(x) can be obtained based on the input X, and a difference (f(x)-Y) between a predicted value and a real value can be calculated. This is a loss function. An aim is to find an appropriate weight and offset, so that the above-mentioned loss function can be minimized. A smaller loss value indicates a closer degree of the model to an actual case.

Currently, all common optimization algorithms are basically based on an error (error) back propagation (Back Propagation, BP) algorithm. A basic idea of the BP algorithm is that a learning process consists of two processes: signal forward propagation and error back propagation. During forward propagation, an input sample is transferred from an input layer to an output layer after being processed by each hidden layer. If an actual output of the output layer does not match an expected output, an error back propagation stage is performed. Error back propagation is to transmit an output error layer by layer to the input layer through a hidden layer in some form for back propagation, and allocate the error to all units of each layer, to obtain an error signal of a unit at each layer. This error signal is used as a basis for correcting a weight of each unit. Such a process adjusting a weight of each layer during signal forward propagation and error back propagation is carried out repeatedly. A process of continuously adjusting a weight is a learning and training process of a network. This process continues until errors output by the network are reduced to an acceptable level or until a preset quantity of learning times are reached.

Common optimization algorithms include gradient descent (Gradient Descent), stochastic gradient descent (Stochastic Gradient Descent, SGD), mini-batch gradient descent (mini-batch gradient descent), momentum (Momentum), stochastic gradient descent with momentum (Nesterov), adaptive gradient descent (Adaptive Gradient descent, Adagrad), adaptive learning rate adjustment (Adadelta), root mean square prop (root mean square prop, RMSprop), adaptive moment estimation (Adaptive Moment Estimation, Adam), and the like.

During error back propagation, in these optimization algorithms, an error/loss is obtained based on the loss function, a gradient is obtained by calculating a derivative/partial derivative of a current neuron and adding a learning rate and a previous gradient/derivative/partial derivative, and the gradient is transferred to an upper layer.

A CSI compression restoring procedure is as follows: The terminal estimates a CSI-RS, calculates channel information, obtains an encoding result from the calculated channel information or original estimated channel information by using the AI network model, and sends the encoding result to the base station. The base station receives the encoding result, inputs the encoding result into the AI network model for decoding, and restores the channel information.

Specifically, in a neural network-based CSI compression feedback solution, the terminal compresses and encodes channel information, and sends compressed content to the base station; and the base station decodes the compressed content, to restore the channel information. In this case, a decoding AI network model of the base station and an encoding AI network model of the terminal need to be jointly trained to achieve a proper matching degree. An input of the encoding AI network model is the channel information, and an output is encoded information, that is, channel characteristic information. An input of the decoding AI network model is the encoded information, and an output is restored channel information.

The channel information that is input to the encoding AI network model is generally a channel matrix or a precoding matrix of all sub-bands. A precoding matrix is used as an example. A quantity of columns of the precoding matrix is a rank (rank) quantity, that is, a total quantity of layers (layer), and a quantity of rows of the precoding matrix is a CSI-RS port quantity. In this way, an input dimension of the encoding AI network model is jointly determined by the rank quantity, the CSI-RS port quantity, and a sub-band quantity. In a related technology, channel information of each channel is processed by using one encoding AI network model. In this way, for CSI-RS with different sub-band quantities, an AI network model of a corresponding input dimension needs to be used for processing. For example, an input dimension of an AI network model is channel information of a CSI-RS of 26 sub-bands, and an input dimension of another AI network model is channel information of a CSI-RS of 13 sub-bands. Because the input dimension of the channel information of the CSI-RS of the 26 sub-bands is twice as much as that of the channel information of the CSI-RS of the 13 sub-bands, the AI network model of the 26 sub-bands cannot be directly used to process the channel information of the CSI-RS of the 13 sub-bands, or the AI network model of the 13 sub-bands cannot be directly used to process the channel information of the CSI-RS of the 26 sub-bands.

In the related technology, AI network models that are in a one-to-one correspondence with a quantity of all sub-bands need to be trained and configured. In this way, complexity of training the AI network model is increased, and overheads of transferring the AI network model are increased.

In the embodiments of this application, frequency domain resources are grouped, and channel information corresponding to at least one frequency domain resource in a group is processed by using one AI network model, so that an AI network model corresponding to a low quantity of frequency domain resources can process channel information corresponding to a high quantity of frequency domain resources, a quantity of AI network models is reduced, and a size of the AI network model is reduced.

For example, a CSI-RS has 26 sub-bands, the 26 sub-bands are grouped into 13 groups, and each group includes two sub-bands. In this case, one AI network model may be multiplexed to separately process channel information of 13 groups of sub-bands, and an input dimension of the AI network model is decreased to channel information of two sub-bands.

With reference to the accompanying drawings, the following describes in detail, by using some embodiments and application scenarios thereof, an information transmission method, an information processing method, an information transmission apparatus, an information processing apparatus, and a communication device provided in the embodiments of this application.

Referring to FIG. 2, an embodiment of this application provides an information transmission method. The information transmission method is performed by a terminal. As shown in FIG. 2, the information transmission method performed by the terminal may include the following steps:

Step 201: The terminal determines K groups of second channel information from first channel information based on first information, where the first information includes group information of K groups of frequency domain resources, the K groups of second channel information are in a one-to-one correspondence with the K groups of frequency domain resources, each group of frequency domain resources in the K groups of frequency domain resources includes at least one frequency domain resource, and K is an integer greater than or equal to 1.

Frequency domain resources may be grouped based on a frequency domain resource unit such as a sub-band or a physical resource block (Physical Resource Block, PRB). For ease of description, in this embodiment of this application, as an example for description, the frequency domain resource is a sub-band. This does not constitute specific limitations herein.

The first channel information may be complete channel information of a channel, and may be specifically at least one of an original channel matrix or vector, a precoding matrix or vector, a preprocessed channel matrix or vector, and a preprocessed precoding matrix or vector. For ease of description, in this embodiment of this application, generally, as an example for description, the channel information is a precoding matrix. This does not constitute specific limitations herein.

The first information is used to group frequency domain resources of a CSI-RS into K groups. In this way, the K groups of second information indicate channel information obtained by the terminal by separately measuring a CSI-RS transmitted on a corresponding group of frequency domain resources.

In an optional implementation, the second channel information may include at least one of the following:
an original channel matrix or vector;
a precoding matrix or vector;
a preprocessed channel matrix or vector; and
a preprocessed precoding matrix or vector.

In an implementation, the preprocessing may include preprocessing of compressing channel information of frequency domain resources in a same group, for example, performing sub-band compression-related preprocessing on channel information of sub-bands in a same group. For example, based on proximity of channel quality of two sub-bands in a group of frequency domain resources, channel information of the two sub-bands may be compressed, to reduce a length of preprocessed channel information, thereby reducing complexity of performing first processing on the preprocessed channel information, and reducing a resource loss of transmitting first-preprocessed channel characteristic information.

In an implementation, in a case that the second channel information is channel information of one layer, a channel matrix corresponding to the channel information of the layer has only one column. In this case, the second channel information may be referred to as a vector. Certainly, in a case that the second channel information includes channel information of at least two layers, the channel information of the at least two layers may be processed into a vector through preprocessing, which is not specifically described herein.

In an optional implementation, the group information of the K groups of frequency domain resources includes at least one of the following:
a value of K;
a quantity of frequency domain resources in each group of frequency domain resources;
an identifier of a frequency domain resource in each group of frequency domain resources;
a frequency domain spacing between frequency domain resources in each group of frequency domain resources;
a frequency domain span of a frequency domain resource in each group of frequency domain resources;
a starting frequency domain resource location of each group of frequency domain resources;
an ending frequency domain resource location of each group of frequency domain resources;
density of each group of frequency domain resources; and
an offset value of each group of frequency domain resources.

Option 1: In a case that the group information of the K groups of frequency domain resources includes the value of K, frequency domain resources of the CSI-RS may be evenly grouped into K groups, for example, one group includes three sub-bands; or frequency domain resources of the CSI-RS are grouped into K uneven groups, for example, one group includes three sub-bands, and one group includes four sub-bands.

Option 2: In a case that the group information of the K groups of frequency domain resources includes the quantity of frequency domain resources in each group of frequency domain resources, frequency domain resources of the CSI-RS may be grouped into K groups based on the quantity of frequency domain resources in each group of frequency domain resources.

It should be noted that, in a case that the group information of the K groups of frequency domain resources includes the quantity of frequency domain resources in each group of frequency domain resources, the quantity of frequency domain resources in each group of frequency domain resources is fixed. However, specific frequency domain resources in a group of frequency domain resources may be adjusted. For example, the terminal may sequentially group the frequency domain resources of the CSI-RS into groups based on an arrangement sequence of the frequency domain resources of the CSI-RS. For example, if the frequency domain resources of the CSI-RS include 13 sub-bands, the first information indicates that a first group of frequency domain resources includes three sub-bands, a second group of frequency domain resources includes four sub-bands, and a third group of frequency domain resources includes six sub-bands, and in this case, the terminal may group a first sub-band to a third sub-band of the CSI-RS into one group, group a fourth sub-band to a seventh sub-band into one group, and group an eighth sub-band to a thirteenth sub-band into one group. Alternatively, the terminal may randomly group the frequency domain resources of the CSI-RS into groups. A specific grouping rule of the terminal may be specified in a protocol, may be indicated by a network side device, or may be independently determined by the terminal.

Option 3: In a case that the group information of the K groups of frequency domain resources includes the identifier of the frequency domain resource in each group of frequency domain resources, the frequency domain resources of the CSI-RS may be grouped based on the identifier of the frequency domain resource. For example, the first information directly indicates that a sub-band 1, a sub-band 4, a sub-band 5, and a sub-band 6 are grouped into one group, a sub-band 2 and a sub-band 3 are grouped into one group, and sub-bands 7 to 13 are grouped into one group.

Option 4: In a case that the group information of the K groups of frequency domain resources includes the frequency domain spacing of the frequency domain resources in each group of frequency domain resources, the K groups of frequency domain resources may correspond to a same frequency domain spacing or different frequency domain spacings. In this case, adjacent frequency domain resources in each group of frequency domain resources may be discontinuous in frequency domain. For example, it is assumed that there are eight sub-bands in total, where a sub-band in a middle part undergoes deep fading. In this case, a sub-band 1, a sub-band 2, a sub-band 7, and a sub-band 8 may be grouped into a group of frequency domain resources, and sub-bands 3 to 6 may be grouped into a group of frequency domain resources. In this case, frequency domain spacings of sub-bands in the two groups of frequency domain resources are different. Sub-bands with close channel quality may be located in a same group of frequency domain resources.

Option 5: In a case that the group information of the K groups of frequency domain resources includes the frequency domain span of the frequency domain resource in each group of frequency domain resources, a span from a starting frequency domain resource location of frequency domain resources in each group to an ending frequency domain resource location is fixed. In this case, all or some frequency domain resources in a frequency domain span may be grouped into one group. For example, it is assumed that the frequency domain span of the frequency domain resource in each group of frequency domain resources is three sub-bands. In this case, a first group of frequency domain resources may include a first sub-band to a third sub-band, and a second group of frequency domain resources may include a fourth sub-band to a sixth sub-band. Certainly, in implementation, frequency domain spans of frequency domain resources in different groups may be different.

Option 6: In a case that the group information of the K groups of frequency domain resources includes the starting frequency domain resource location of each group of frequency domain resources, the starting frequency domain resource location of the frequency domain resource in each group of frequency domain resources is fixed, and the frequency domain location of the frequency domain resource in each group of frequency domain resources includes the starting frequency domain resource location and a frequency domain resource that is located after the starting frequency domain resource location. For example, it is assumed that a starting frequency domain resource location of a specific group of frequency domain resources is a fourth sub-band, and a frequency domain degree of the group of frequency domain resources is three sub-bands, and in this case, it may be determined that the group of frequency domain resources includes the fourth sub-band to a sixth sub-band.

Option 7: In a case that the group information of the K groups of frequency domain resources includes the ending frequency domain resource location of each group of frequency domain resources, the ending frequency domain resource location of each group of frequency domain resources is fixed, and the frequency domain location of the frequency domain resource in each group of frequency domain resources includes the ending frequency domain resource location and a frequency domain resource that is located before the ending frequency domain resource location. For example, it is assumed that an ending frequency domain resource location of a specific group of frequency domain resources is a fourth sub-band, and a frequency domain span of the group of frequency domain resources is three sub-bands, and in this case, it may be determined that the group of frequency domain resources includes a second sub-band to the fourth sub-band.

Option 8: In a case that the group information of the K groups of frequency domain resources includes the density of each group of frequency domain resources, frequency domain resources in each group of frequency domain resources may meet comb distribution. For example, it is assumed that density of frequency domain resources in each group of frequency domain resources is 2, odd-numbered sub-bands in all sub-bands of the CSI-RS may be grouped into one group, and even-numbered sub-bands may be grouped into one group.

It should be noted that the foregoing density of the frequency domain resources in the group of frequency domain resources may be understood in the following two manners:

(1) The density indicates a ratio of each frequency domain resource to one group of frequency domain resources. For example, if sub-band density is 0.5, it indicates that each sub-band occupies 0.5 of one group of sub-bands. In this case, every two sub-bands correspond to one group of sub-bands, that is, one of two consecutive sub-bands belongs to a first group of sub-bands, and the other belongs to a second group of sub-bands.

(2) The density indicates that every several frequency domain resources in a group of frequency domain resources are not repeated. For example, in the foregoing example, density 2 indicates that every two consecutive sub-bands do not appear in a same group of sub-bands, that is, one sub-band in every two sub-bands belongs to a first group of sub-bands, and the other sub-band belongs to a second group of sub-bands.

Option 9: In a case that the group information of the K groups of frequency domain resources includes the offset value of each group of frequency domain resources, a frequency domain resource in each group of frequency domain resources may be determined based on an offset of a frequency domain location of a frequency domain resource relative to a reference frequency domain location. For example, it is assumed that a starting frequency domain location of a frequency domain resource in a group of frequency domain resources is used as the reference frequency domain location, and another frequency domain resource in the group of frequency domain resources may be determined by using an offset value, indicated by first information, of the another frequency domain resource in the group of frequency domain resources relative to the reference frequency domain location. Alternatively, the reference frequency domain location may be any default frequency domain location such as 0. This is not specifically limited herein.

It should be noted that the group information of the K groups of frequency domain resources may include at least two of the foregoing options 1 to 9. For example, the group information of the K groups of frequency domain resources includes the starting frequency domain location and the ending frequency domain resource location of each group of frequency domain resources in the K groups of frequency domain resources. In this case, a part of frequency domain resources located between the starting frequency domain location and the ending frequency domain resource location may be selected as a corresponding group of frequency domain resources, or frequency domain resources located between a starting frequency domain location and an ending frequency domain resource location of a same group of frequency domain resources may be used as the group of frequency domain resources. For example, if it is indicated that a starting frequency domain location of a group of frequency domain resources is a third sub-band, and an ending frequency domain resource location is an eighth sub-band, it may be determined that the group of frequency domain resources includes the third sub-band to the eighth sub-band.

Step 202: The terminal performs first processing on M groups of second channel information based on first AI network models respectively corresponding to the M groups of second channel information to obtain M pieces of channel characteristic information, where the K groups of second channel information include the M groups of second channel information, and M is a positive integer less than or equal to K.

In an implementation, the first AI network model may be an encoding AI network model and/or a compression AI network model, that is, an AI network model that obtains CSI-related information by processing channel information on a terminal side. A name of the first AI network model is not specifically limited herein. For ease of description, in this embodiment of this application, as an example for description, the first AI network model is an encoding AI network model. The encoding AI network model matches a decoding AI network model and/or a decompression AI network model (that is, the second AI network model in this embodiment of this application) of the network side device, and/or the first AI network model is jointly trained with the second AI network model of the network side device. Correspondingly, the second AI network model may be an AI network model used by a base station side to process channel characteristic information, and a name of the second AI network model is not specifically limited herein. For ease of description, in this embodiment of this application, as an example for description, the second AI network model is a decoding AI network model.

In an implementation, the first processing may include at least one of compression processing, encoding processing, and quantization processing. For ease of description, in this embodiment of this application, as an example for description, the first processing is encoding processing.

In an implementation, the M groups of second channel information may correspond to a same first AI network model. In this case, a common first AI network model is used to separately perform first processing on the M groups of second channel information to obtain channel characteristic information that is output by the first AI network model for M times.

In an implementation, the M groups of second channel information may correspond to different first AI network models. In this case, M first AI network models separately perform first processing on groups of second channel information respectively corresponding to the M groups of second channel information to obtain channel characteristic information that is separately output by the M first AI network models.

In an implementation, one part of the M groups of second channel information may correspond to a same first AI network model, and the other part may correspond to different first AI network models. For example, the M groups of second channel information are divided into two parts, V groups of second channel information in a first part use a same first AI network model, (M-V) groups of second channel information in a second part use a same first AI network model, and the first AI network model used by the V groups of second channel information and the first AI network model used by the (M-X) groups of second channel information are not a same first AI network model.

Step 203: The terminal sends second information to the network side device, where the second information includes the M pieces of channel characteristic information.

In an implementation, the terminal may send the second information to the network side device in a CSI reporting manner, or the terminal sends the second information to the network side device in a signaling manner. This is not specifically limited herein.

In an optional implementation, in a case that each group of frequency domain resources in the K groups of frequency domain resources includes L frequency domain resources and H cannot be evenly divided by L, the first information includes a processing rule for channel information of X frequency domain resources, H is a quantity of frequency domain resources of a channel corresponding to the first channel information, X is equal to a remainder left after H is divided by L, and L, X, and H each are an integer greater than or equal to 1.

In an implementation, in a case that H cannot be evenly divided by L, a remainder part, that is, channel information of the X frequency domain resources, may be processed according to at least one of the following processing rules:

1) A first group of frequency domain resources is formed based on Y frequency domain resources and the X frequency domain resources, where the K groups of frequency domain resources include the first group of frequency domain resources, and the frequency domain resources of the channel corresponding to the first channel information include the Y frequency domain resources.

In an implementation, Y is equal to L. In this case, the X frequency domain resources may be combined into any group of frequency domain resources. For example, if H is equal to 13, and L is equal to 6, 13 sub-bands may be grouped into two groups, and a remaining one sub-band left after division is combined into a first group of frequency domain resources or a second group of frequency domain resources. For example, first six sub-bands are a group, and last seven sub-bands are a group; or odd-numbered sub-bands or sub-bands with odd numbers are a group, and even-numbered sub-bands or sub-bands with even numbers are another group. Optionally, two groups of sub-bands may use a same AI network model or different AI network models. If two groups of sub-bands have different quantities of sub-bands, channel information of one group with a smaller quantity of sub-bands may be supplemented into an input dimension of the AI network model in a manner of supplementing 0s.

In an implementation, Y is equal to (L-X). In this case, the X frequency domain resources and repeated (L-X) frequency domain resources may constitute a group of frequency domain resources, and the group of frequency domain resources has L frequency domain resources. The repeated (L-X) frequency domain resources may mean that one frequency domain resource in this group or another group is repeated (L-X) times, or (L-X) frequency domain resources in this group or another group occur repeatedly in the first group of frequency domain resources. For example, it is assumed that His equal to 13 and L is equal to 6, and in this case, 13 sub-bands may be grouped into three groups, where a first group includes a sub-band 1 to a sub-band 6, a second group includes a sub-band 7 to a sub-band 12, and a third group includes a sub-band 13 and five repeated sub-bands. Sub-bands in the third group may be [1, 2, 3, 4, 5, 13], or sub-bands [12, 12, 12, 12, 12, 12, 13], or sub-bands [13, 13, 13, 13, 13, 13], or sub-bands [8, 9, 10, 11, 12, 13], and are not exhaustive herein.

In an implementation, Y is equal to 0, and in this case, the X frequency domain resources are directly used as a group of frequency domain resources.

2) Reporting of channel information of the X frequency domain resources is skipped. For example, the first processing is not performed on the channel information of the X frequency domain resources, and channel characteristic information corresponding to the channel information of the X frequency domain resources is not reported.

3) A dimension of channel information of the X frequency domain resources is supplemented to a target dimension, where the target dimension is a dimension of channel information of the L frequency domain resources. A manner of supplementing the dimension of the channel information of the X frequency domain resources to the target dimension may be supplementing 0s or supplementing an interpolation value determined according to a preset rule. In a case of supplementing the interpolation value determined according to the preset rule, the preset rule may be trained with the first AI network model and the second AI network model. After obtaining the M pieces of channel characteristic information, the network side device restores the M groups of second channel information based on the second AI network models respectively corresponding to the M pieces of channel characteristic information, and discards the supplemented interpolation value according to the foregoing preset rule.

In an optional implementation, the first information meets at least one of the following:
being indicated by the network side device;
being selected and reported by the terminal;
being agreed upon in a protocol; and
being associated with the first AI network model.

In an implementation, the network side device may indicate group information of the frequency domain resource by using signaling, for example, includes a quantity K of groups or a quantity of frequency domain resources in each group of frequency domain resources, or a specific frequency domain resource or specific frequency domain resources specifically included in each group of frequency domain resources.

In an implementation, the network side device may configure the group information of the frequency domain resource in a CSI report configuration (report config).

In an implementation, the terminal may determine a grouping manner of frequency domain resources based on an input dimension of the first AI network model of the terminal, so that each group of second channel information obtained after the grouping matches the input dimension of the first AI network model of the terminal.

In implementation, if the terminal selects or determines the first information, the terminal may report the first information to the network side device.

In an optional implementation, frequency domain resources in a same group meet at least one of the following:
having a same frequency domain span or different frequency domain spans;
having a same frequency domain spacing or different frequency domain spacings;
having partially overlapping frequency domain locations or non-overlapping frequency domain locations; and
a difference between corresponding channel quality being less than a preset threshold.

In an implementation, a frequency domain span of a frequency domain resource in a same group may be a frequency domain range of a single frequency domain resource in the group of frequency domain resources, for example, a group of frequency domain resources includes a frequency domain resource A and a frequency domain resource B, where a frequency range of the frequency domain resource A is 2800 Hz to 3000 Hz, that is, a frequency domain span of the frequency domain resource A is 200 Hz, and a frequency range of the frequency domain resource B is 3100 Hz to 3200 Hz, that is, a frequency domain span of the frequency domain resource B is 100 Hz.

In an implementation, a frequency domain spacing of frequency domain resources in a same group may be an interval frequency between two adjacent frequency domain resources in a group of frequency domain resources. For example, a group of frequency domain resources includes a sub-band 1, a sub-band 2, and a sub-band 4, where a frequency domain spacing between the sub-band 1 and the sub-band 2 is one sub-band, and a frequency domain spacing between the sub-band 2 and the sub-band 4 is two sub-bands.

In an implementation, that frequency domain locations of frequency domain resources in a same group partially overlap may be: frequency domain locations of at least two frequency domain resources in a group of frequency domain resources partially overlap. For example, a group of frequency domain resources includes a frequency domain resource A and a frequency domain resource B, where a frequency range of the frequency domain resource A is 2800 Hz to 3150 Hz, and a frequency range of the frequency domain resource B is 3100 Hz to 3200 Hz. In this case, the frequency range of the frequency domain resource A and the frequency range of the frequency domain resource B partially overlap. Correspondingly, that frequency domain locations of frequency domain resources in a same group do not overlap may be: frequency domain locations of at least two frequency domain resources in a group of frequency domain resources completely do not overlap. Details are not described herein again.

In an implementation, that a difference between channel quality corresponding to frequency domain resources in a same group is less than a preset threshold may be: frequency domain resources with close channel quality are grouped into one group. For example, it is assumed that there are eight sub-bands in total, where a sub-band in a middle part undergoes deep fading. In this case, a sub-band 1, a sub-band 2, a sub-band 7, and a sub-band 8 may be grouped into a group of frequency domain resources, and sub-bands 3 to 6 may be grouped into a group of frequency domain resources. In this case, sub-bands with close channel quality may be located in a same group of frequency domain resources.

In an optional implementation, before the terminal determines the K groups of second channel information from the first channel information based on the first information, the method further includes:
the terminal receives first indication information from the network side device, where the first indication information indicates the first information, an identifier of the first information, or an identifier of the first AI network model, and the first AI network model is associated with the first information; and
the terminal determines the first information based on the first indication information.

In an implementation, the terminal learns a first association relationship between the first information and the identifier of the first information. Specifically, association relationships between various first information and identifiers of the first information may be agreed upon in a protocol or configured by the network side device in advance. In this way, in a case that the network side device indicates the identifier of the first information, the terminal may determine the first information based on an association relationship between the identifier and the first information.

In an implementation, that the first AI network model is associated with the first information may be: the first information is trained and/or transferred together with the first AI network model. For example, in a process of training the first AI network model, a frequency domain spacing and a frequency domain resource quantity of channel information that can be input into the first AI network model are determined. In this way, when obtaining the first AI network model, the terminal also obtains the first information associated with the first AI network model. In this way, the network side device may indicate a specific first AI network model used by the terminal, and the terminal determines, based on this, first information associated with the used first AI network model.

In an implementation, first information associated with each of at least two first AI network models may be agreed upon in a protocol or configured by the network side device in advance. In this way, in a case that the network side device indicates an identifier of a first AI network model, the terminal may determine the first information based on the association relationship between the identifier and the first information.

In an implementation, the first indication information may be included in a CSI report configuration (CSI report config).

In this implementation, the first information may be indicated or configured by the network side device.

In an optional implementation, the information transmission method further includes:
the terminal sends second indication information to the network side device, where the second indication information indicates the first information, an identifier of the first information, or an identifier of the first AI network model, and the first AI network model is associated with the first information.

In an implementation, the network side device may indicate a part of the first information and/or a part of the first information may be agreed upon in a protocol. The terminal determines complete first information according to an instruction of the network side device and/or an agreement in the protocol. For example, it is assumed that the network side device indicates that K=4, it is agreed upon in the protocol that X frequency domain resources left after H is divided by L and (L-X) frequency domain resources constitute a first group of frequency domain resources, and the terminal learns that a rank (rank) of a target downlink channel is equal to 13. In this case, the terminal determines to group 13 sub-bands into four groups. In this case, the terminal may determine, according to an instruction of a network side and the agreement in the protocol, a quantity of sub-bands included in each group of frequency domain resources, and/or determine a specific sub-band or specific sub-bands specifically included in each group of frequency domain resources. For example, a first group of frequency domain resources includes sub-bands 1 to 4, a second group includes sub-bands 5 to 8, a third group includes sub-bands 9 to 12, and a fourth group includes sub-bands 10 to 13; or a first group includes sub-bands 1 to 4, a second group of frequency domain resources includes sub-bands 4 to 7, a third group of frequency domain resources includes sub-bands 7 to 10, and a fourth group of frequency domain resources includes sub-bands 10 to 13; or a first group of frequency domain resources includes sub-bands 1 to 4, a second group of frequency domain resources includes sub-bands 5 to 8, a third group of frequency domain resources includes sub-bands 9 to 12, and a fourth group of frequency domain resources includes sub-bands [12, 12, 12, 13].

In an implementation, the terminal may determine, based on the input dimension of the first AI network model of the terminal, a quantity of frequency domain resources included in each group of frequency domain resources. For example, a dimension of each group of second channel information obtained through division based on the first information matches an input dimension of the first AI network model.

In an implementation, the information transmission method may further include:
the terminal determines a frequency domain resource in each group of frequency domain resources in the K groups of frequency domain resources based on third information, where the group information of the K groups of frequency domain resources includes a correspondence between the K groups of frequency domain resources and frequency domain resources respectively included in the K groups of frequency domain resources; where
the third information includes a frequency domain spacing, agreed upon in a protocol, of frequency domain resources in each group of frequency domain resources, and a quantity of frequency domain resources in each group of frequency domain resources that is indicated by the network side device or the value of K.

For example, it is assumed that it is agreed upon in a protocol that a frequency domain spacing of frequency domain resources in each group of frequency domain resources is 2. In this case, a quantity, indicated by the network side device, of frequency domain resources in each group of frequency domain resources is 4, or it is indicated that K is equal to 4. If an actual sub-band quantity of a target downlink channel is 16, the terminal may determine to group the 16 sub-bands into four groups, for example, a first group includes sub-bands [1, 3, 5, 7], a second group includes sub-bands [2, 4, 6, 8], a third group includes sub-bands [9, 11, 13, 15], and a fourth group includes sub-bands [10, 12, 14, 16].

In an implementation, the information transmission method may further include:
the terminal determines a frequency domain resource in each group of frequency domain resources in the K groups of frequency domain resources based on fourth information, where the group information of the K groups of frequency domain resources includes a correspondence between the K groups of frequency domain resources and frequency domain resources respectively included in the K groups of frequency domain resources; where
the fourth information includes the processing rule agreed upon in a protocol, and a target frequency domain spacing and/or a target frequency domain resource quantity associated with the first AI network model, where the target frequency domain spacing is a frequency domain spacing of frequency domain resources in one group of frequency domain resources, and the target frequency domain resource quantity is a quantity of frequency domain resources in one group of frequency domain resources.

For example, it is assumed that it is agreed upon in a protocol that a processing rule for X frequency domain resources left after H is divided by L is “not reporting” and it is agreed upon that a target frequency domain spacing associated with at least one first AI network model is 1 and a quantity L of target frequency domain resources is 4. If an actual sub-band quantity H of a target downlink channel is 13, X is equal to 1. In this case, the terminal may determine to group the 13 sub-bands into three groups, where a first group includes sub-bands [1, 2, 3, 4], a second group includes sub-bands [5, 6, 7, 8], and a third group includes sub-bands [9, 10, 11, 12], and the terminal does not perform first processing on a sub-band 13, and does not report channel characteristic information obtained after first processing is performed on the sub-band 13.

For another example, it is assumed that it is agreed upon in a protocol that a processing rule for X frequency domain resources left after H is divided by L is: supplementing channel information of the X frequency domain resources into a length of channel information of L frequency domain resources as a group of frequency domain resources, and it is agreed upon that a target frequency domain spacing associated with at least one first AI network model is 1 and a target frequency domain resource quantity L is 4. If an actual sub-band quantity H of a target downlink channel is 13, X is equal to 1. In this case, the terminal may determine to group the 13 sub-bands into four groups, where a first group includes sub-bands [1, 2, 3 4], a second group includes sub-bands [5, 6, 7, 8], a third group includes sub-bands [9, 10, 11, 12], and a fourth group includes sub-bands [13, 0, 0, 0].

In this implementation, the terminal may report the selected first information to the network side device, so that after obtaining the second information, the network side device can determine, based on the first information reported by the terminal, channel information of which frequency domain resource that each piece of channel characteristic information is based on, to restore channel information of these frequency domain resources and obtain the first channel information.

In an optional implementation, the information transmission method further includes:
the terminal determines target capability information to the network side device, where the target capability information indicates a capability of whether the terminal supports frequency domain resource grouping.

Optionally, the target capability information further includes at least one of the following:
whether the terminal supports frequency domain resource grouping;
a maximum quantity of frequency domain resource groups supported by the terminal;
an identifier of a frequency domain resource group supported by the terminal;
a quantity of frequency domain resource groups processed in parallel that are supported by the terminal; and
a frequency domain spacing, supported by the terminal, between frequency domain resources in a same group.

In this implementation, the terminal reports the target capability information to the network side device, so that in a case that the network side device configures or indicates the first information, the network side device configures or indicates, for the terminal, first information that can be supported by the terminal; and/or in a case that the network side device configures or indicates the first AI network model, the network side device configures or indicates, for the terminal, a first AI network model that matches a capability of the terminal.

In an optional implementation, the information transmission method further includes:
the terminal receives fifth information from the network side device, where the fifth information indicates and/or configures the first AI network models respectively corresponding to the M groups of second channel information, or the fifth information indicates first AI network models corresponding to at least some groups of second channel information in the M groups of second channel information; and
the terminal determines the first information based on the fifth information.

In an implementation, the M groups of second channel information may correspond to different first AI network models. In this case, the network side device indicates, by using the fifth information, a first AI network model used by each group of second channel information. In this way, the terminal may determine, according to an instruction of the network side device, the first AI network model corresponding to each group of second channel information, and determine, based on the first AI network model, that a group of second channel information can be processed into first information that conforms to an input format of the corresponding first AI network model.

In an implementation, at least some groups of second channel information may correspond to a same first AI network model. In this case, the network side device indicates, by using the fifth information, the first AI network model used by the at least some groups of second channel information. In this way, the terminal may determine, according to an instruction of the network side device, the first AI network model corresponding to the at least some groups of second channel information, and determine, based on the first AI network model, that the at least some groups of second channel information can be processed into first information that conforms to an input format of the corresponding first AI network model.

In this implementation, the network side device may indicate a first AI network model corresponding to each group of second channel information or at least some groups of second channel information.

In an optional implementation, the information transmission method further includes:
the terminal sends third indication information to the network side device, where the third indication information indicates the first AI network models respectively corresponding to the M groups of second channel information.

In this implementation, the terminal may select and report, to the network side device, the first AI network model corresponding to each group of second channel information or at least some groups of second channel information.

In an optional implementation, the first AI network models respectively corresponding to the M groups of second channel information meet at least one of the following:
frequency domain resource groups including a same quantity of frequency domain sources correspond to a same first AI network model;
the M groups of second channel information correspond to a same first AI network model;
a dimension of a group of second channel information matches an input information dimension of a corresponding first AI network model; and
the network side device indicates first AI network models respectively corresponding to the M groups of second channel information.

In an implementation, the first AI network model corresponds to a value of L. For example, a group of frequency domain resources with two sub-bands and a group of frequency domain resources with three sub-bands correspond to different first AI network models. The input dimension of the first AI network model may match dimensions of channel information of the L corresponding frequency domain resources.

In an implementation, the M groups of second channel information may correspond to a same first AI network model. For example, the M groups of second channel information are separately input into a same first AI network model, to obtain the M pieces of channel characteristic information obtained by performing first processing on the first AI network model for M times.

In an implementation, the terminal may determine, according to an instruction of the network side device, a first AI network model corresponding to each group of second channel information.

In this embodiment of this application, frequency domain resources are grouped, and channel information of each group of frequency domain resources is processed by using a corresponding AI network model. First channel information of one channel can be divided into K groups, and only channel information of a corresponding group of frequency domain resources is input into each AI network model, but channel information of an entire channel does not need to be input. In this way, an AI network model with a low quantity of frequency domain resources can be used to process channel information of a high quantity of frequency domain resources, thereby improving multiplexing efficiency and flexibility of the AI network model.

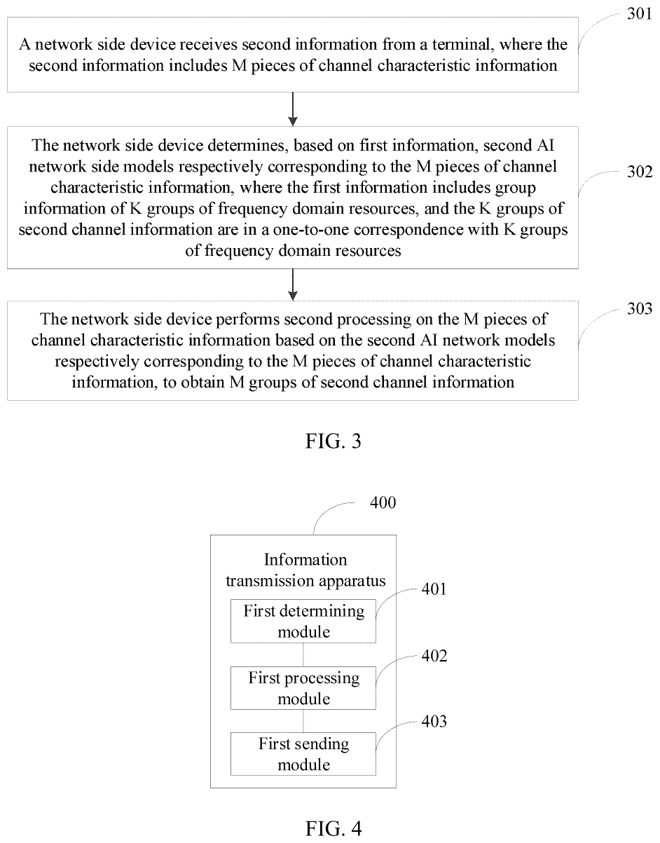

Referring to FIG. 3, an information processing method is provided in an embodiment of this application. The information processing method may be performed by a network side device. As shown in FIG. 3, the information processing method may include the following steps:

Step 301: The network side device receives second information from a terminal, where the second information includes M pieces of channel characteristic information, the M pieces of channel characteristic information are channel characteristic information obtained by performing first processing on M groups of second channel information based on first AI network models respectively corresponding to the M groups of second channel information, and M is an integer greater than or equal to 1.

A meaning of the second information is the same as that of the second information in the method embodiment shown in FIG. 2. Details are not described herein again.

Step 302: The network side device determines, based on first information, second AI network models respectively corresponding to the M pieces of channel characteristic information, where the first information includes group information of K groups of frequency domain resources, the K groups of second channel information are in a one-to-one correspondence with the K groups of frequency domain resources, each group of frequency domain resources in the K groups of frequency domain resources includes at least one frequency domain resource, and K is an integer greater than or equal to M.

A meaning of the first information is the same as a meaning of the first information in the method embodiment shown in FIG. 2. The network side device is configured to determine, based on the first information, the second AI network models respectively corresponding to the M pieces of channel characteristic information, where the first AI network models for obtaining the channel characteristic information and the second AI network models corresponding to the channel characteristic information are mutually matched AI network models or AI network models obtained by joint training, for example, the first AI network model is an encoding AI network model or an encoding part of an AI network model, and the second AI network model is a decoding AI network model or a decoding part of an AI network model.

Step 303: The network side device performs second processing on the M pieces of channel characteristic information based on the second AI network models respectively corresponding to the M pieces of channel characteristic information to obtain the M groups of second channel information.

The second processing may include at least one of decoding, decompression, and quantization processing.

In an optional implementation, the frequency domain resource includes a sub-band or a physical resource block PRB.

In an optional implementation, the group information of the K groups of frequency
domain resources includes at least one of the following:
a value of K;
a quantity of frequency domain resources in each group of frequency domain resources;
an identifier of a frequency domain resource in each group of frequency domain resources;
a frequency domain spacing between frequency domain resources in each group of frequency domain resources;
a frequency domain span of a frequency domain resource in each group of frequency domain resources;
a starting frequency domain resource location of each group of frequency domain resources;
an ending frequency domain resource location of each group of frequency domain resources;
density of each group of frequency domain resources; and
an offset value of each group of frequency domain resources.

In an optional implementation, in a case that each group of frequency domain resources in the K groups of frequency domain resources includes L frequency domain resources and H cannot be evenly divided by L, the first information includes a processing rule for channel information of X frequency domain resources, H is a quantity of frequency domain resources of a channel corresponding to the first channel information, X is equal to a remainder left after H is divided by L, and L, X, and H each are an integer greater than or equal to 1.

Optionally, the processing rule includes at least one of the following:
forming a first group of frequency domain resources based on (L-X) frequency domain resources and the X frequency domain resources, where the K groups of frequency domain resources include the first group of frequency domain resources, and the frequency domain resources of the channel corresponding to the first channel information include the (L-X) frequency domain resources;
skipping reporting channel information of the X frequency domain resources; and
supplementing a dimension of channel information of the X frequency domain resources to a target dimension, where the target dimension is a dimension of channel information of the L frequency domain resources.

In this implementation, the network side device can restore the channel information of the X frequency domain resources according to a processing rule for processing the channel information of the X frequency domain resources, or in a case that the processing rule for processing the channel information of the X frequency domain resources is skipping reporting the channel information of the X frequency domain resources, the network side device does not obtain channel characteristic information corresponding to the channel information of the X frequency domain resources. In this case, the network side device may obtain and restore channel information of another part.

In an optional implementation, the first information meets at least one of the following:
being indicated by the network side device;
being selected and reported by the terminal;
being agreed upon in a protocol; and
being associated with the first AI network model.

In an optional implementation, frequency domain resources in a same group meet at least one of the following:
having a same frequency domain span or different frequency domain spans;
having a same frequency domain spacing or different frequency domain spacings;
having partially overlapping frequency domain locations or non-overlapping frequency domain locations; and
a difference between corresponding channel quality being less than a preset threshold.

In an optional implementation, before the network side device receives the second information from the terminal, the information processing method further includes:
the network side device sends first indication information to the terminal, where the first indication information indicates the first information, an identifier of the first information, or an identifier of the first AI network model, and the first AI network model is associated with the first information.

In an optional implementation, before the network side device determines, based on the first information, the second AI network models respectively corresponding to the M pieces of channel characteristic information, the information processing method further includes:
the network side device receives second indication information from the terminal, where the second indication information indicates the first information, an identifier of the first information, or an identifier of the first AI network model, and the first AI network model is associated with the first information; and
the network side device determines the first information based on the second indication information.

In an optional implementation, the second channel information includes at least one of the following:
an original channel matrix or vector;
a precoding matrix or vector;
a preprocessed channel matrix or vector; and
a preprocessed precoding matrix or vector.

In an optional implementation, the information processing method further includes:
the network side device receives target capability information from the terminal, where the target capability information indicates a capability of whether the terminal supports frequency domain resource grouping.

In an optional implementation, the target capability information indicates at least one of the following:
whether the terminal supports frequency domain resource grouping;
a maximum quantity of frequency domain resource groups supported by the terminal;
an identifier of a frequency domain resource group supported by the terminal;
a quantity of frequency domain resource groups processed in parallel that are supported by the terminal; and
a frequency domain spacing, supported by the terminal, between frequency domain resources in a same group.

In an optional implementation, the information processing method further includes:
the network side device sends fifth information to the terminal, where the fifth information indicates and/or configures the first AI network models respectively corresponding to the M groups of second channel information, or the fifth information indicates first AI network models corresponding to at least some groups of second channel information in the M groups of second channel information.

In an optional implementation, the information processing method further includes:
the network side device receives third indication information from the terminal, where the third indication information indicates the first AI network models respectively corresponding to the M groups of second channel information.

In this implementation, the terminal may select and report the first AI network models respectively corresponding to the M groups of second channel information. In this way, the network side device may determine, based on the first AI network models respectively corresponding to the M groups of second channel information, the second AI network models respectively corresponding to the M groups of second channel information, where a first AI network model and a second AI network model that are corresponding to a same group of second channel information are an encoding AI network model and a decoding AI network model that match each other or that are obtained through joint training.

In an optional implementation, the first AI network models respectively corresponding to the M groups of second channel information meet at least one of the following:
frequency domain resource groups including a same quantity of frequency domain resources correspond to a same first AI network model;
the M groups of second channel information correspond to a same first AI network model;
a dimension of a group of second channel information matches an input information dimension of a corresponding first AI network model; and
the network side device indicates first AI network models respectively corresponding to the M groups of second channel information.

In this embodiment of this application, the network side device receives the M pieces of channel characteristic information from the terminal, and determines, based on the first information, the second AI network models respectively corresponding to the M pieces of channel characteristic information, to restore corresponding channel characteristic information to the second channel information by using the second AI network model, thereby implementing a channel characteristic information receiving and restoring process. An input of the second AI network model is channel characteristic information of some frequency domain resources, so that a model size of the second AI network model is relatively small. In addition, a same quantity of frequency domain resources may be grouped into one group, so that a same second AI network model may be repeatedly used for channels with different quantities of channels. In this way, an AI network model of a low quantity of frequency domain resources can be used to process channel information with a high quantity of frequency domain resources, thereby improving multiplexing efficiency and flexibility of the AI network model.

The information transmission method provided in the embodiments of this application may be performed by an information transmission apparatus. In the embodiments of this application, that the information transmission apparatus performs the information transmission method is used as an example to describe the information transmission apparatus provided in the embodiments of this application.

Referring to FIG. 4, an information transmission apparatus provided in an embodiment of this application may be an apparatus in a terminal. As shown in FIG. 4, the information transmission apparatus 400 may include the following modules:
a first determining module 401, configured to determine K groups of second channel information from first channel information based on first information, where the first information includes group information of K groups of frequency domain resources, the K groups of second channel information are in a one-to-one correspondence with the K groups of frequency domain resources, each group of frequency domain resources in the K groups of frequency domain resources includes at least one frequency domain resource, and K is an integer greater than or equal to 1;
a first processing module 402, configured to perform first processing on M groups of second channel information based on first AI network models respectively corresponding to the M groups of second channel information, to obtain M pieces of channel characteristic information, where the K groups of second channel information include the M groups of second channel information, and M is a positive integer less than or equal to K; and
a first sending module 403, configured to send second information to a network side device, where the second information includes the M pieces of channel characteristic information.

Optionally, the frequency domain resource includes a sub-band or a physical resource block PRB.

Optionally, the group information of the K groups of frequency domain resources includes at least one of the following:
a value of K;
a quantity of frequency domain resources in each group of frequency domain resources;
an identifier of a frequency domain resource in each group of frequency domain resources;
a frequency domain spacing between frequency domain resources in each group of frequency domain resources;
a frequency domain span of a frequency domain resource in each group of frequency domain resources;
a starting frequency domain resource location of each group of frequency domain resources;
an ending frequency domain resource location of each group of frequency domain resources;
density of each group of frequency domain resources; and
an offset value of each group of frequency domain resources.

Optionally, in a case that each group of frequency domain resources in the K groups of frequency domain resources includes L frequency domain resources and H cannot be evenly divided by L, the first information includes a processing rule for channel information of X frequency domain resources, H is a quantity of frequency domain resources of a channel corresponding to the first channel information, X is equal to a remainder left after H is divided by L, and L, X, and H each are an integer greater than or equal to 1.

Optionally, the processing rule includes at least one of the following:
forming a first group of frequency domain resources based on Y frequency domain resources and the X frequency domain resources, where the K groups of frequency domain resources include the first group of frequency domain resources, and the frequency domain resources of the channel corresponding to the first channel information include the Y frequency domain resources;
skipping reporting channel information of the X frequency domain resources; and
supplementing a dimension of channel information of the X frequency domain resources to a target dimension, where the target dimension is a dimension of channel information of the L frequency domain resources.

Optionally, the first information meets at least one of the following:
being indicated by the network side device;
being selected and reported by the terminal;
being agreed upon in a protocol; and
being associated with the first AI network model.

Optionally, frequency domain resources in a same group meet at least one of the following:
having a same frequency domain span or different frequency domain spans;
having a same frequency domain spacing or different frequency domain spacings;
having partially overlapping frequency domain locations or non-overlapping frequency domain locations; and
a difference between corresponding channel quality being less than a preset threshold.

Optionally, the information transmission apparatus 400 further includes:
a second receiving module, configured to receive first indication information from the network side device, where the first indication information indicates the first information, an identifier of the first information, or an identifier of the first AI network model, and the first AI network model is associated with the first information; and
a third determining module, configured to determine the first information based on the first indication information.

Optionally, the information transmission apparatus 400 further includes:
a second sending module, configured to send second indication information to the network side device, where the second indication information indicates the first information, an identifier of the first information, or an identifier of the first AI network model, and the first AI network model is associated with the first information.

Optionally, the information transmission apparatus 400 further includes:
a fourth determining module, configured to determine a frequency domain resource in each group of frequency domain resources in the K groups of frequency domain resources based on third information, where the group information of the K groups of frequency domain resources includes a correspondence between the K groups of frequency domain resources and frequency domain resources respectively included in the K groups of frequency domain resources; where
the third information includes a frequency domain spacing, agreed upon in a protocol, of frequency domain resources in each group of frequency domain resources, and a quantity of frequency domain resources in each group of frequency domain resources that is indicated by the network side device or the value of K.

Optionally, the information transmission apparatus 400 further includes:
a fifth determining module, configured to determine a frequency domain resource in each group of frequency domain resources in the K groups of frequency domain resources based on fourth information, where the group information of the K groups of frequency domain resources includes a correspondence between the K groups of frequency domain resources and frequency domain resources respectively included in the K groups of frequency domain resources; where
the fourth information includes the processing rule agreed upon in a protocol, and a target frequency domain spacing and/or a target frequency domain resource quantity associated with the first AI network model, where the target frequency domain spacing is a frequency domain spacing of frequency domain resources in one group of frequency domain resources, and the target frequency domain resource quantity is a quantity of frequency domain resources in one group of frequency domain resources.

Optionally, the second channel information includes at least one of the following:
an original channel matrix or vector;
a precoding matrix or vector;
a preprocessed channel matrix or vector; and
a preprocessed precoding matrix or vector.

Optionally, the preprocessing includes preprocessing of compressing channel information of frequency domain resources in a same group.

Optionally, the information transmission apparatus 400 further includes:
a third sending module, configured to send target capability information to the network side device, where the target capability information indicates a capability of whether the terminal supports frequency domain resource grouping.

Optionally, the target capability information further includes at least one of the following:
whether the terminal supports frequency domain resource grouping;
a maximum quantity of frequency domain resource groups supported by the terminal;
an identifier of a frequency domain resource group supported by the terminal;
a quantity of frequency domain resource groups processed in parallel that are supported by the terminal; and
a frequency domain spacing, supported by the terminal, between frequency domain resources in a same group.

Optionally, the information transmission apparatus 400 further includes:
a third receiving module, configured to receive fifth information from the network side device, where the fifth information indicates and/or configures the first AI network models respectively corresponding to the M groups of second channel information, or the fifth information indicates first AI network models corresponding to at least some groups of second channel information in the M groups of second channel information; and
a sixth determining module, configured to determine the first information based on the fifth information.

Optionally, the information transmission apparatus 400 further includes:
a fourth sending module, configured to send third indication information to the network side device, where the third indication information indicates first AI network models respectively corresponding to the M groups of second channel information.

Optionally, the first AI network models respectively corresponding to the M groups of second channel information meet at least one of the following:
frequency domain resource groups including a same quantity of frequency domain resources correspond to a same first AI network model;
the M groups of second channel information correspond to a same first AI network model;
a dimension of a group of second channel information matches an input information dimension of a corresponding first AI network model; and
the network side device indicates first AI network models respectively corresponding to the M groups of second channel information.

The information transmission apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (Network Attached Storage, NAS), or the like. This is not specifically limited in this embodiment of this application.

The information transmission apparatus 400 provided in this embodiment of this application can implement the processes performed by the terminal in the method embodiment shown in FIG. 2, and a same beneficial effect can be achieved. To avoid repetition, details are not described herein again.

The information processing method provided in the embodiments of this application may be performed by an information processing apparatus. In the embodiments of this application, that the information processing apparatus performs the information processing method is used as an example to describe the information processing apparatus provided in the embodiments of this application.

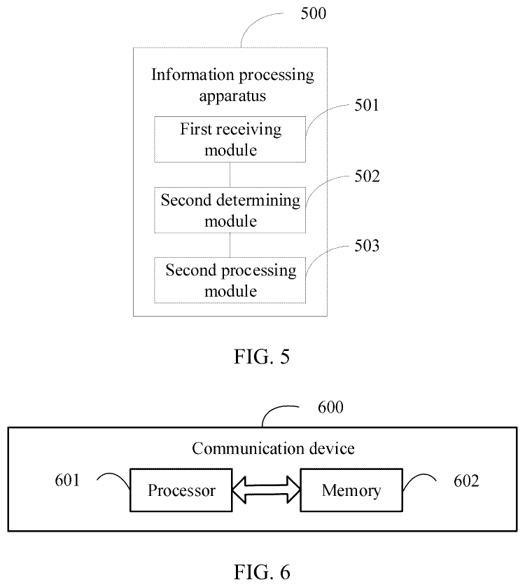

Referring to FIG. 5, an information processing apparatus provided in an embodiment of this application may be an apparatus in a network side device. As shown in FIG. 5, the information processing apparatus 500 may include the following modules:
a first receiving module 501, configured to receive second information from a terminal, where the second information includes M pieces of channel characteristic information, the M pieces of channel characteristic information are channel characteristic information obtained by performing first processing on M groups of second channel information based on first AI network models respectively corresponding to the M groups of second channel information, and M is an integer greater than or equal to 1;
a second determining module 502, configured to determine, based on first information, second AI network models respectively corresponding to the M pieces of channel characteristic information, where the first information includes group information of K groups of frequency domain resources, the K groups of second channel information are in a one-to-one correspondence with the K groups of frequency domain resources, each group of frequency domain resources in the K groups of frequency domain resources includes at least one frequency domain resource, and K is an integer greater than or equal to M; and
a second processing module 503, configured to perform second processing on the M pieces of channel characteristic information based on the second AI network models respectively corresponding to the M pieces of channel characteristic information to obtain the M groups of second channel information.

Optionally, the frequency domain resource includes a sub-band or a physical resource block PRB.

Optionally, the group information of the K groups of frequency domain resources includes at least one of the following:

a value of K;

a quantity of frequency domain resources in each group of frequency domain resources;

an identifier of a frequency domain resource in each group of frequency domain resources;

a frequency domain spacing between frequency domain resources in each group of frequency domain resources;

a frequency domain span of a frequency domain resource in each group of frequency domain resources;

a starting frequency domain resource location of each group of frequency domain resources;

an ending frequency domain resource location of each group of frequency domain resources;

density of each group of frequency domain resources; and
an offset value of each group of frequency domain resources.

Optionally, in a case that each group of frequency domain resources in the K groups of frequency domain resources includes L frequency domain resources and H cannot be evenly divided by L, the first information includes a processing rule for channel information of X frequency domain resources, H is a quantity of frequency domain resources of a channel corresponding to the first channel information, X is equal to a remainder left after H is divided by L, and L, X, and H each are an integer greater than or equal to 1.

Optionally, the processing rule includes at least one of the following:

forming a first group of frequency domain resources based on (L-X) frequency domain resources and the X frequency domain resources, where the K groups of frequency domain resources include the first group of frequency domain resources, and the frequency domain resources of the channel corresponding to the first channel information include the (L-X) frequency domain resources;

skipping reporting channel information of the X frequency domain resources; and
supplementing a dimension of channel information of the X frequency domain resources to a target dimension, where the target dimension is a dimension of channel information of the L frequency domain resources.

Optionally, the first information meets at least one of the following:

being indicated by the network side device;
being selected and reported by the terminal;
being agreed upon in a protocol; and
being associated with the first AI network model.

Optionally, frequency domain resources in a same group meet at least one of the following:

having a same frequency domain span or different frequency domain spans;
having a same frequency domain spacing or different frequency domain spacings;
having partially overlapping frequency domain locations or non-overlapping frequency domain locations; and
a difference between corresponding channel quality being less than a preset threshold.

Optionally, the information processing apparatus 500 further includes:

a fifth sending module, configured to send first indication information to the terminal, where the first indication information indicates the first information, an identifier of the first information, or an identifier of the first AI network model, and the first AI network model is associated with the first information.

Optionally, the information processing apparatus 500 further includes:

a fourth receiving module, configured to receive second indication information from the terminal, where the second indication information indicates the first information, an identifier of the first information, or an identifier of the first AI network model, and the first AI network model is associated with the first information; and
a seventh determining module, configured to determine the first information based on the second indication information.

Optionally, the second channel information includes at least one of the following: an original channel matrix or vector;
a precoding matrix or vector;
a preprocessed channel matrix or vector; and
a preprocessed precoding matrix or vector.

Optionally, the information processing apparatus 500 further includes:
a fifth receiving module, configured to receive target capability information from the terminal, where the target capability information indicates a capability of whether the terminal supports frequency domain resource grouping.

Optionally, the target capability information further includes at least one of the following:

whether the terminal supports frequency domain resource grouping;

a maximum quantity of frequency domain resource groups supported by the terminal;

an identifier of a frequency domain resource group supported by the terminal;

a quantity of frequency domain resource groups processed in parallel that are supported by the terminal; and
a frequency domain spacing, supported by the terminal, between frequency domain resources in a same group.

Optionally, the information processing apparatus 500 further includes:
a sixth sending module, configured to send fifth information to the terminal, where the fifth information indicates and/or configures the first AI network models respectively corresponding to the M groups of second channel information, or the fifth information indicates first AI network models corresponding to at least some groups of second channel information in the M groups of second channel information.

Optionally, the information processing apparatus 500 further includes:

a sixth receiving module, configured to receive third indication information from the terminal, where the third indication information indicates the first AI network models respectively corresponding to the M groups of second channel information.

Optionally, the first AI network models respectively corresponding to the M groups of second channel information meet at least one of the following:
frequency domain resource groups including a same quantity of frequency domain resources correspond to a same first AI network model;

the M groups of second channel information correspond to a same first AI network model;

a dimension of a group of second channel information matches an input information dimension of a corresponding first AI network model; and
the network side device indicates first AI network models respectively corresponding to the M groups of second channel information.

The information processing apparatus 500 provided in this embodiment of this application can perform the processes performed by the network side device in the method embodiment shown in FIG. 3, and a same beneficial effect can be achieved. To avoid repetition, details are not described herein again.

Optionally, as shown in FIG. 6, an embodiment of this application further provides a communication device 600, including a processor 601 and a memory 602, and the memory 602 stores a program or instructions capable of running on the processor 601. For example, in a case that the communication device 600 is a terminal, when the program or the instructions are executed by the processor 601, the steps of the method embodiment shown in FIG. 2 are implemented, and a same technical effect can be achieved. In a case that the communication device 600 is a network side device, when the program or the instructions are executed by the processor 601, the steps of the method embodiment shown in FIG. 3 are implemented, and a same technical effect can be achieved. To avoid repetition, details are not described herein again.

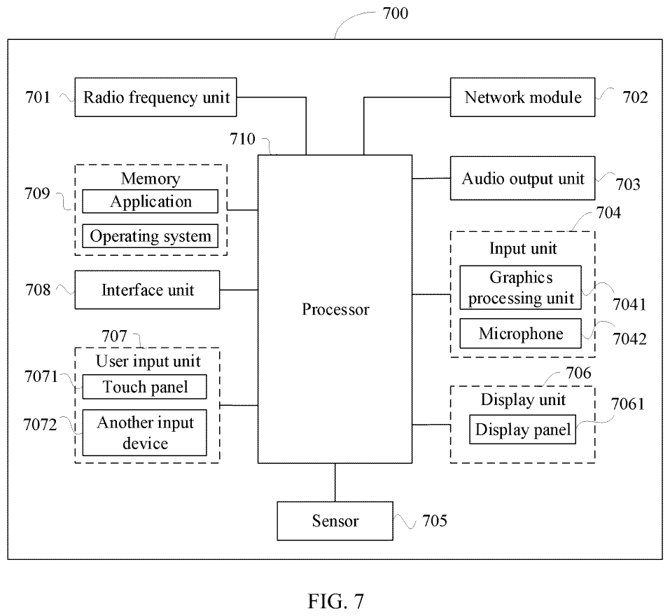

An embodiment of this application further includes a terminal, including a processor and a communication interface. The processor is configured to determine K groups of second channel information from first channel information based on first information, where the first information includes group information of K groups of frequency domain resources, the K groups of second channel information are in a one-to-one correspondence with the K groups of frequency domain resources, each group of frequency domain resources in the K groups of frequency domain resources includes at least one frequency domain resource, and K is an integer greater than or equal to 1. The processor is further configured to perform first processing on M groups of second channel information based on first AI network models respectively corresponding to the M groups of second channel information, to obtain M pieces of channel characteristic information, where the K groups of second channel information include the M groups of second channel information, and M is a positive integer less than or equal to K. The communication interface is configured to send second information to a network side device, where the second information includes the M pieces of channel characteristic information. In this embodiment of the terminal, the processes performed by the information transmission apparatus 400 shown in FIG. 4 can be implemented, and a same technical effect can be achieved. Details are not described herein again. Specifically, FIG. 7 is a schematic diagram of a hardware structure of a terminal according to an embodiment of this application.

The terminal 700 includes but is not limited to at least a part of components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include a power supply (such as a battery) that supplies power to each component. The power supply may be logically connected to the processor 710 by using a power supply management system, to implement functions such as charging and discharging management, and power consumption management by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that in this embodiment of this application, the input unit 704 may include a graphics processing unit (Graphics Processing Unit, GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Generally, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The nonvolatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 709 in this embodiment of this application includes but is not limited to these memories and any memory of another proper type.

The processor 710 may include one or more processing units. Optionally, an application processor and a modem processor are integrated into the processor 710. The application processor mainly processes an operating system, a user interface, an application, and the like. The modem processor mainly processes a wireless communication signal, for example, a baseband processor. It may be understood that, alternatively, the modem processor may not be integrated into the processor 710.

The processor 710 is configured to determine K groups of second channel information from first channel information based on first information, where the first information includes group information of K groups of frequency domain resources, the K groups of second channel information are in a one-to-one correspondence with the K groups of frequency domain resources, each group of frequency domain resources in the K groups of frequency domain resources includes at least one frequency domain resource, and K is an integer greater than or equal to 1.

The processor 710 is further configured to perform first processing on M groups of second channel information based on first AI network models respectively corresponding to the M groups of second channel information to obtain M pieces of channel characteristic information, where the K groups of second channel information include the M groups of second channel information, and M is a positive integer less than or equal to K.

The radio frequency unit 701 is configured to send second information to a network side device, where the second information includes the M pieces of channel characteristic information.

Optionally, the frequency domain resource includes a sub-band or a physical resource block PRB.

Optionally, the group information of the K groups of frequency domain resources includes at least one of the following:

a value of K;

a quantity of frequency domain resources in each group of frequency domain resources;

an identifier of a frequency domain resource in each group of frequency domain resources;

a frequency domain spacing between frequency domain resources in each group of frequency domain resources;

a frequency domain span of a frequency domain resource in each group of frequency domain resources;

a starting frequency domain resource location of each group of frequency domain resources;

an ending frequency domain resource location of each group of frequency domain resources;

density of each group of frequency domain resources; and
an offset value of each group of frequency domain resources.

Optionally, in a case that each group of frequency domain resources in the K groups of frequency domain resources includes L frequency domain resources and H cannot be evenly divided by L, the first information includes a processing rule for channel information of X frequency domain resources, H is a quantity of frequency domain resources of a channel corresponding to the first channel information, X is equal to a remainder left after H is divided by L, and L, X, and H each are an integer greater than or equal to 1.

Optionally, the processing rule includes at least one of the following:
forming a first group of frequency domain resources based on Y frequency domain resources and the X frequency domain resources, where the K groups of frequency domain resources include the first group of frequency domain resources, and the frequency domain resources of the channel corresponding to the first channel information include the Y frequency domain resources;

skipping reporting channel information of the X frequency domain resources; and
supplementing a dimension of channel information of the X frequency domain resources to a target dimension, where the target dimension is a dimension of channel information of the L frequency domain resources.

Optionally, the first information meets at least one of the following:
being indicated by the network side device;
being selected and reported by the terminal;
being agreed upon in a protocol; and
being associated with the first AI network model.

Optionally, frequency domain resources in a same group meet at least one of the following:

having a same frequency domain span or different frequency domain spans;
having a same frequency domain spacing or different frequency domain spacings;
having partially overlapping frequency domain locations or non-overlapping frequency domain locations; and
a difference between corresponding channel quality being less than a preset threshold.

Optionally, before the processor 710 determines the K groups of second channel information from the first channel information based on the first information,
the radio frequency unit 701 is further configured to receive first indication information from the network side device, where the first indication information indicates the first information, an identifier of the first information, or an identifier of the first AI network model, and the first AI network model is associated with the first information.

The processor 710 is further configured to determine the first information based on the first indication information.

Optionally, the radio frequency unit 701 is further configured to send second indication information to the network side device, where the second indication information indicates the first information, an identifier of the first information, or an identifier of the first AI network model, and the first AI network model is associated with the first information.

Optionally, the processor 710 is further configured to determine a frequency domain resource in each group of frequency domain resources in the K groups of frequency domain resources based on third information, where the group information of the K groups of frequency domain resources includes a correspondence between the K groups of frequency domain resources and frequency domain resources respectively included in the K groups of frequency domain resources; where
the third information includes a frequency domain spacing, agreed upon in a protocol, of frequency domain resources in each group of frequency domain resources, and a quantity of frequency domain resources in each group of frequency domain resources that is indicated by the network side device or the value of K.

Optionally, the processor 710 is further configured to determine a frequency domain resource in each group of frequency domain resources in the K groups of frequency domain resources based on fourth information, where the group information of the K groups of frequency domain resources includes a correspondence between the K groups of frequency domain resources and frequency domain resources respectively included in the K groups of frequency domain resources; where
the fourth information includes the processing rule agreed upon in a protocol, and a target frequency domain spacing and/or a target frequency domain resource quantity associated with the first AI network model, where the target frequency domain spacing is a frequency domain spacing of frequency domain resources in one group of frequency domain resources, and the target frequency domain resource quantity is a quantity of frequency domain resources in one group of frequency domain resources.

Optionally, the second channel information includes at least one of the following:
an original channel matrix or vector;

a precoding matrix or vector;

a preprocessed channel matrix or vector; and
a preprocessed precoding matrix or vector.

Optionally, the preprocessing includes preprocessing of compressing channel information of frequency domain resources in a same group.

Optionally, the radio frequency unit 701 is further configured to send target capability information to the network side device, where the target capability information indicates a capability of whether the terminal supports frequency domain resource grouping.

Optionally, the target capability information further includes at least one of the following:

whether the terminal supports frequency domain resource grouping;
a maximum quantity of frequency domain resource groups supported by the terminal;

an identifier of a frequency domain resource group supported by the terminal;
a quantity of frequency domain resource groups processed in parallel that are supported by the terminal; and
a frequency domain spacing, supported by the terminal, between frequency domain resources in a same group.

Optionally, the radio frequency unit 701 is further configured to receive fifth information from the network side device, where the fifth information indicates and/or configures the first AI network models respectively corresponding to the M groups of second channel information, or the fifth information indicates first AI network models corresponding to at least some groups of second channel information in the M groups of second channel information; and
the processor 710 is further configured to determine the first information based on the fifth information.

Optionally, the radio frequency unit 701 is further configured to send third indication information to the network side device, where the third indication information indicates the first AI network models respectively corresponding to the M groups of second channel information.

Optionally, the first AI network models respectively corresponding to the M groups of second channel information meet at least one of the following:

frequency domain resource groups including a same quantity of frequency domain resources correspond to a same first AI network model;
the M groups of second channel information correspond to a same first AI network model;

a dimension of a group of second channel information matches an input information dimension of a corresponding first AI network model; and
the network side device indicates first AI network models respectively corresponding to the M groups of second channel information.

The terminal 700 provided in this embodiment of this application can perform the processes performed by the information transmission apparatus 400 shown in FIG. 4, and a same beneficial effect can be achieved. To avoid repetition, details are not described herein again.

An embodiment of this application further provides a network side device, including a processor and a communication interface. The communication interface is configured to receive second information from a terminal, where the second information includes M pieces of channel characteristic information, the M pieces of channel characteristic information are channel characteristic information obtained by performing first processing on M groups of second channel information based on first AI network models respectively corresponding to the M groups of second channel information, and M is an integer greater than or equal to 1. The processor is configured to determine, based on first information, second AI network models respectively corresponding to the M pieces of channel characteristic information, where the first information includes group information of K groups of frequency domain resources, the K groups of second channel information are in a one-to-one correspondence with the K groups of frequency domain resources, each group of frequency domain resources in the K groups of frequency domain resources includes at least one frequency domain resource, and K is an integer greater than or equal to M. The processor is further configured to perform second processing on the M pieces of channel characteristic information based on the second AI network models respectively corresponding to the M pieces of channel characteristic information, to obtain the M groups of second channel information.

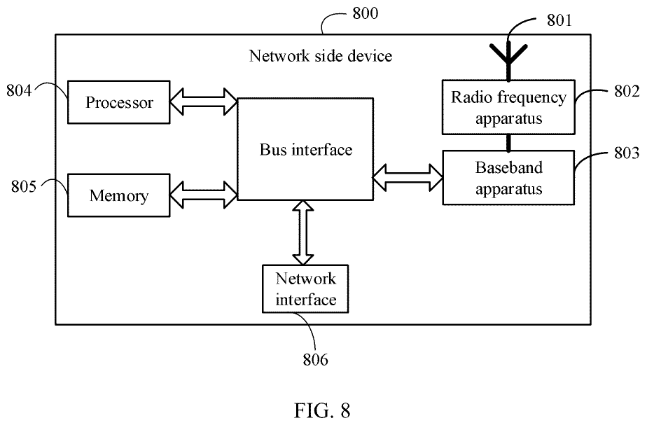

In this embodiment of the network side device, the processes performed by the information processing apparatus 500 shown in FIG. 5 can be implemented, and a same technical effect can be achieved. Details are not described herein again. Specifically, an embodiment of this application further provides a network side device. As shown in FIG. 8, the network side device 800 includes an antenna 801, a radio frequency apparatus 802, a baseband apparatus 803, a processor 804, and a memory 805. The antenna 801 is connected to the radio frequency apparatus 802. In an uplink direction, the radio frequency apparatus 802 receives information through the antenna 801, and sends the received information to the baseband apparatus 803 for processing. In a downlink direction, the baseband apparatus 803 processes information that needs to be sent, and sends processed information to the radio frequency apparatus 802. The radio frequency apparatus 802 processes the received information, and sends processed information through the antenna 801.

In the foregoing embodiment, the method performed by the network side device may be implemented in the baseband apparatus 803. The baseband apparatus 803 includes a baseband processor.

For example, the baseband apparatus 803 may include at least one baseband board. A plurality of chips are disposed on the baseband board. As shown in FIG. 8, one chip is, for example, a baseband processor, and is connected to the memory 805 by using a bus interface, to invoke a program in the memory 805 to perform the operations of the network device shown in the foregoing method embodiment.

The network side device may further include a network interface 806, and the interface is, for example, a common public radio interface (Common Public Radio Interface, CPRI).

Specifically, the network side device 800 in this embodiment of this application further includes an instruction or a program that is stored in the memory 805 and that can run on the processor 804. The processor 804 invokes the instruction or the program in the memory 805 to perform the method performed by the modules shown in FIG. 5, and a same technical effect is achieved. To avoid repetition, details are not described herein again.

An embodiment of this application further provides a readable storage medium. The readable storage medium stores a program or instructions. When the program or the instructions are executed by a processor, the processes of the method embodiment in FIG. 2 or FIG. 3 can be implemented, and a same technical effect can be achieved. To avoid repetition, details are not described herein.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or instructions to implement the processes of the method embodiment shown in FIG. 2 or FIG. 3, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a non-volatile storage medium, and the computer program/program product is executed by at least one processor to implement the processes of the method embodiment shown in FIG. 2 or FIG. 3, and a same technical effect can be achieved. To avoid repetition, details are not described herein again.

An embodiment of this application further provides a communication system, including a terminal and a network side device. The terminal may be configured to perform the steps of the information transmission method shown in FIG. 2, and the network side device may be configured to perform the steps of the information processing method shown in FIG. 3.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. An information transmission method, comprising:
determining, by a terminal, K groups of second channel information from first channel information based on first information, wherein the first information comprises group information of K groups of frequency domain resources, the K groups of second channel information are in a one-to-one correspondence with the K groups of frequency domain resources, each group of frequency domain resources in the K groups of frequency domain resources comprises at least one frequency domain resource, and K is an integer greater than or equal to 1;
performing, by the terminal, first processing on M groups of second channel information based on first AI network models respectively corresponding to the M groups of second channel information, to obtain M pieces of channel characteristic information, wherein the K groups of second channel information comprise the M groups of second channel information, and M is a positive integer less than or equal to K; and
sending, by the terminal, second information to a network side device, wherein the second information comprises the M pieces of channel characteristic information.

2. The method according to claim 1, wherein the group information of the K groups of frequency domain resources comprises at least one of the following:
a value of K;
a quantity of frequency domain resources in each group of frequency domain resources;
an identifier of a frequency domain resource in each group of frequency domain resources;
a frequency domain spacing between frequency domain resources in each group of frequency domain resources;
a frequency domain span of a frequency domain resource in each group of frequency domain resources;
a starting frequency domain resource location of each group of frequency domain resources;
an ending frequency domain resource location of each group of frequency domain resources;
density of each group of frequency domain resources; and
an offset value of each group of frequency domain resources.

3. The method according to claim 1, wherein in a case that each group of frequency domain resources in the K groups of frequency domain resources comprises L frequency domain resources and H cannot be evenly divided by L, the first information comprises a processing rule for channel information of X frequency domain resources, H is a quantity of frequency domain resources of a channel corresponding to the first channel information, X is equal to a remainder left after H is divided by L, and L, X, and H each are an integer greater than or equal to 1.

4. The method according to claim 3, wherein the processing rule comprises at least one of the following:
forming a first group of frequency domain resources based on Y frequency domain resources and the X frequency domain resources, wherein the K groups of frequency domain resources comprise the first group of frequency domain resources, and the frequency domain resources of the channel corresponding to the first channel information comprise the Y frequency domain resources;
skipping reporting channel information of the X frequency domain resources; and
supplementing a dimension of channel information of the X frequency domain resources to a target dimension, wherein the target dimension is a dimension of channel information of the L frequency domain resources.

5. The method according to claim 1, wherein the first information meets at least one of the following:
being indicated by the network side device;
being selected and reported by the terminal;
being agreed upon in a protocol; and
being associated with the first AI network model.

6. The method according to claim 1, wherein before the determining, by a terminal, K groups of second channel information from first channel information based on first information, the method further comprises:
receiving, by the terminal, first indication information from the network side device, wherein the first indication information indicates the first information, an identifier of the first information, or an identifier of the first AI network model, and the first AI network model is associated with the first information; and
determining, by the terminal, the first information based on the first indication information.

7. The method according to claim 1, wherein the method further comprises:
sending, by the terminal, second indication information to the network side device, wherein the second indication information indicates the first information, an identifier of the first information, or an identifier of the first AI network model, and the first AI network model is associated with the first information.

8. The method according to claim 1, wherein the method further comprises:
sending, by the terminal, target capability information to the network side device, wherein the target capability information indicates a capability of whether the terminal supports frequency domain resource grouping, and the target capability information indicates at least one of the following:
whether the terminal supports frequency domain resource grouping;
a maximum quantity of frequency domain resource groups supported by the terminal;
an identifier of a frequency domain resource group supported by the terminal;
a quantity of frequency domain resource groups processed in parallel that are supported by the terminal; and
a frequency domain spacing, supported by the terminal, between frequency domain resources in a same group.

9. The method according to claim 1, wherein the method further comprises:
receiving, by the terminal, fifth information from the network side device, wherein the fifth information indicates and/or configures the first AI network models respectively corresponding to the M groups of second channel information, or the fifth information indicates first AI network models corresponding to at least some groups of second channel information in the M groups of second channel information; and
determining, by the terminal, the first information based on the fifth information; or
sending, by the terminal, third indication information to the network side device, wherein the third indication information indicates the first AI network models respectively corresponding to the M groups of second channel information.

10. An information processing method, comprising:
receiving, by a network side device, second information from a terminal, wherein the second information comprises M pieces of channel characteristic information, the M pieces of channel characteristic information are channel characteristic information obtained by performing first processing on M groups of second channel information based on first AI network models respectively corresponding to the M groups of second channel information, and M is an integer greater than or equal to 1;
determining, by the network side device based on first information, second AI network models respectively corresponding to the M pieces of channel characteristic information, wherein the first information comprises group information of K groups of frequency domain resources, K groups of second channel information are in a one-to-one correspondence with the K groups of frequency domain resources, each group of frequency domain resources in the K groups of frequency domain resources comprises at least one frequency domain resource, and K is an integer greater than or equal to M; and
performing, by the network side device, second processing on the M pieces of channel characteristic information based on the second AI network models respectively corresponding to the M pieces of channel characteristic information, to obtain the M groups of second channel information.

11. The method according to claim 10, wherein the group information of the K groups of frequency domain resources comprises at least one of the following:
a value of K;
a quantity of frequency domain resources in each group of frequency domain resources;
an identifier of a frequency domain resource in each group of frequency domain resources;
a frequency domain spacing between frequency domain resources in each group of frequency domain resources;
a frequency domain span of a frequency domain resource in each group of frequency domain resources;
a starting frequency domain resource location of each group of frequency domain resources;
an ending frequency domain resource location of each group of frequency domain resources;
density of each group of frequency domain resources; and
an offset value of each group of frequency domain resources.

12. The method according to claim 10, wherein in a case that each group of frequency domain resources in the K groups of frequency domain resources comprises L frequency domain resources and H cannot be evenly divided by L, the first information comprises a processing rule for channel information of X frequency domain resources, H is a quantity of frequency domain resources of a target downlink channel, X is equal to a remainder left after H is divided by L, L, X, and H each are an integer greater than or equal to 1, and the target downlink channel is a channel corresponding to the second channel information.

13. The method according to claim 12, wherein the processing rule comprises at least one of the following:
forming a first group of frequency domain resources based on (L-X) frequency domain resources and the X frequency domain resources, wherein the K groups of frequency domain resources comprise the first group of frequency domain resources, and the frequency domain resources of the target downlink channel comprise the (L-X) frequency domain resources;
skipping reporting channel information of the X frequency domain resources; and
supplementing a dimension of channel information of the X frequency domain resources to a target dimension, wherein the target dimension is a dimension of channel information of the L frequency domain resources.

14. The method according to claim 10, wherein the first information meets at least one of the following:
being indicated by the network side device;
being selected and reported by the terminal;
being agreed upon in a protocol; and
being associated with the first AI network model.

15. The method according to claim 10, wherein before the receiving, by a network side device, second information from a terminal, the method further comprises:
sending, by the network side device, first indication information to the terminal, wherein the first indication information indicates the first information, an identifier of the first information, or an identifier of the first AI network model, and the first AI network model is associated with the first information.

16. The method according to claim 10, wherein before the determining, by the network side device based on first information, second AI network models respectively corresponding to the M pieces of channel characteristic information, the method further comprises:
receiving, by the network side device, second indication information from the terminal, wherein the second indication information indicates the first information, an identifier of the first information, or an identifier of the first AI network model, and the first AI network model is associated with the first information; and
determining, by the network side device, the first information based on the second indication information.

17. The method according to claim 10, wherein the method further comprises:
receiving, by the network side device, target capability information from the terminal, wherein the target capability information indicates a capability of whether the terminal supports frequency domain resource grouping, and the target capability information indicates at least one of the following:
whether the terminal supports frequency domain resource grouping;
a maximum quantity of frequency domain resource groups supported by the terminal;
an identifier of a frequency domain resource group supported by the terminal;
a quantity of frequency domain resource groups processed in parallel that are supported by the terminal; and
a frequency domain spacing, supported by the terminal, between frequency domain resources in a same group.

18. The method according to claim 10, wherein the method further comprises:
sending, by the network side device, fifth information to the terminal, wherein the fifth information indicates and/or configures the first AI network models respectively corresponding to the M groups of second channel information, or the fifth information indicates first AI network models corresponding to at least some groups of second channel information in the M groups of second channel information; or.
receiving, by the network side device, third indication information from the terminal, wherein the third indication information indicates the first AI network models respectively corresponding to the M groups of second channel information.

19. A communication device, comprising a processor and a memory, wherein the memory stores a program or instructions capable of running on the processor, and when the program or the instructions are executed by the processor, the steps of an information transmission method, wherein the information transmission method comprises:
determining, by a terminal, K groups of second channel information from first channel information based on first information, wherein the first information comprises group information of K groups of frequency domain resources, the K groups of second channel information are in a one-to-one correspondence with the K groups of frequency domain resources, each group of frequency domain resources in the K groups of frequency domain resources comprises at least one frequency domain resource, and K is an integer greater than or equal to 1;
performing, by the terminal, first processing on M groups of second channel information based on first AI network models respectively corresponding to the M groups of second channel information, to obtain M pieces of channel characteristic information, wherein the K groups of second channel information comprise the M groups of second channel information, and M is a positive integer less than or equal to K; and
sending, by the terminal, second information to a network side device, wherein the second information comprises the M pieces of channel characteristic information.

20. A communication device, comprising a processor and a memory, wherein the memory stores a program or instructions capable of running on the processor, and when the program or the instructions are executed by the processor, the steps of the information transmission method according to claim 10 is implemented.
